(19) United States
(12) Patent Application Publication
(10) Pub. No.: US 2018/0361896 A1
(43) Pub. Date: Dec. 20, 2018

(54) SEAT SUPPORT ASSEMBLY FORMED BY ADDITIVE MANUFACTURING

(71) Applicant: GM Global Technology Operations LLC, Detroit, MI (US)

(72) Inventors: Brennon L. White, Novi, MI (US); Nilesh D. Mankame, Ann Arbor, MI (US); Daniel J. Ridgeway, Dearborn, MI (US); Steven C. Lang, Columbus, MI (US)

(21) Appl. No.: 15/623,885

(22) Filed: Jun. 15, 2017

(51) Int. Cl. B60N 2/58; B60N 2/70; B29C 67/00; B29B 11/14; B33Y 10/00

(52) U.S. Cl. CPC B60N 2/5816; B60N 2/7017; B60N 2205/30; B29B 11/14; B33Y 10/00; B29C 67/0085

(57) ABSTRACT

A support assembly formed by an additive manufacturing process using a printing head includes a trim member. A body includes multiple layers of at least one polymeric material applied onto the trim member via the printing head. The multiple layers each have multiple resilient polymeric material elements. A protective and abrasion resistant polymeric material cover is applied over the body using the printing head. At least one structural element is positioned in the body by operation of the printing head. At least one sensor is positioned in the body. At least one passage is formed within the body by selective omission of the at least one polymeric material from the printing head as the printing head displaces during the additive manufacturing process.

### INTRODUCTION

The present disclosure relates to additive manufacturing systems and methods.

At present, automotive trim and seat assemblies are created from multiple different components, including padding, heating wires, sensors, tubing or channels added to provide for air flow, different density features to accommodate occupant loading and support, and a cover applied in multiple parts such as by zippers, sewn seams, and/or hook and loop fasteners. Each component adds further to the time required for assembly, costs associated with acquiring, storing, and assembling the multiple components, and the impact on delivery if any one component availability is impeded.

Known vehicle trim and seat assemblies create VOC (volatile organic compound) emissions, have limited recyclability, require extensive assembly labor, limit functional integration of additional features due to access during and after assembly, have limited ability to customize different stiffnesses throughout the parts, require large bend radii particularly at outside corners to receive the cover, and generally require approximately eight to twelve tools per part number, for each part of the assembly.

Thus, while current vehicle trim and seat assemblies achieve their intended purpose, there is a need for a new and improved system and method for designing and assembling vehicle trim and seat assemblies.

### SUMMARY

According to several aspects, a support assembly includes a body including multiple layers of at least one polymeric material applied onto a releasable substrate. A protective and abrasion resistant polymeric material cover is applied at least partially over the body. At least one polymeric material structural element is positioned in the body. At least one sensor is positioned in the body. At least one passage is formed within the body by selective omission of at least one of the multiple layers of the at least one polymeric material.

In another aspect of the present disclosure, the body includes a trim member and the at least one structural element is formed from a same material as the body and defines a stiffness greater than a stiffness of the body.

In another aspect of the present disclosure, the at least one structural element is formed from a polymeric material different than the polymeric material of the body and defines a stiffness greater than a stiffness of the body.

In another aspect of the present disclosure, at least one wire is embedded in the body.

In another aspect of the present disclosure, the at least one wire defines an electrically conductive polymeric material.

In another aspect of the present disclosure, the at least one wire defines a conductive metal embedded as a layer independent of the multiple layers of at least one polymeric material.

In another aspect of the present disclosure, the at least one sensor defines a polymeric material embedded independent of the multiple layers of at least one polymeric material.

In another aspect of the present disclosure, the body includes at least different durometers, different densities, and different compressibilities over a cross section of the support assembly.

In another aspect of the present disclosure, the at least one polymeric material defines a urethane.

In another aspect of the present disclosure, the at least one polymeric material defines a thermoplastic polyurethane (TPU) or a thermoset polymer.

According to several aspects, a support assembly formed by an additive manufacturing process using a printing head includes a trim member. A body has multiple layers of at least one polymeric material applied onto the trim member via the printing head, the multiple layers each having multiple resilient polymeric material elements. A protective and abrasion resistant polymeric material cover is applied over the body and the trim member using the printing head. At least one structural element is positioned in the body by operation of the printing head. At least one sensor positioned in the body. At least one passage is formed within the body by selective omission of the at least one polymeric material from the printing head as the printing head displaces during the additive manufacturing process.

In another aspect of the present disclosure, the at least one structural element defines a stiffness greater than a stiffness of the body.

In another aspect of the present disclosure, the at least one structural element is formed from a same material as the body, or is formed from a different polymeric material than the body.

In another aspect of the present disclosure, at least one wire is embedded in the body.

In another aspect of the present disclosure, the at least one wire defines an electrically conductive polymeric material applied via the printing head.

In another aspect of the present disclosure, the individual layers of the resilient polymeric material elements are oriented in one of a vertically stacked configuration or a vertically staggered configuration.

In another aspect of the present disclosure, the at least one sensor defines a polymeric material applied using the printing head.

In another aspect of the present disclosure, the body varies in at least a durometer, a density, and a compressibility over a cross section of the support assembly; and the at least one polymeric material defines a urethane.

According to several aspects, an automobile vehicle seat support assembly formed by an additive manufacturing process using a printing head includes a body having multiple layers of at least one polymeric material applied via the printing head, the multiple layers each having multiple resilient polymeric material elements. A protective and abrasion resistant polymeric material cover is applied over the body using the printing head. At least one structural element is positioned in the body by operation of the printing head, the at least one structural element having a stiffness greater than a stiffness of the body. At least one wire is embedded in the body, the at least one wire defining an electrically conductive polymeric material applied via the printing head. At least one sensor is positioned in the body formed of a polymeric material applied using the printing head. At least one passage is formed within the body by selective omission of the at least one polymeric material from the printing head as the printing head displaces during the additive manufacturing process.

In another aspect of the present disclosure, the individual layers of the resilient polymeric material elements are oriented in one of a vertically stacked configuration or a vertically staggered configuration; and the individual layers of the resilient polymeric material elements are applied onto a trim member.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a front elevational view of an exemplary automobile vehicle occupant support assembly made using the additive manufacturing process of the present disclosure;

FIG. 2 is a partial cross sectional front perspective view of the automobile vehicle occupant support assembly of FIG. 1;

FIG. 3 is a front cross sectional elevational view of an additive manufacturing mold according to an exemplary aspect;

FIG. 4 is a front cross sectional elevational view of the additive manufacturing mold of FIG. 3 having side seals and a vacuum port added;

FIG. 5 is a front cross sectional elevational view of the additive manufacturing mold of FIG. 4 following installation of a trim member;

FIG. 6 is a front cross sectional elevational view of the additive manufacturing mold of FIG. 5 following additive installation of multiple resilient polymeric material elements and embedding of electrical circuits;

FIG. 7 is a front cross sectional elevational view of the additive manufacturing mold of FIG. 6 following additive installation of support layers, rigid support elements and open channels;

FIG. 8 is a front cross sectional elevational view of the additive manufacturing mold of FIG. 7 following additive installation of a rigid suspension member and embedding sensors;

FIG. 9 is a front cross sectional elevational view of the additive manufacturing mold of FIG. 8 following completion of the additive process, release of the vacuum, and release of the finished part from the mold;

FIG. 10 is a front cross sectional elevational view modified from FIG. 9 following 180 degree rotation of the finished part and rotation of first and second arms of the trim member;

FIG. 11 is a cross sectional side elevational view of the automobile vehicle occupant support assembly of FIG. 1;

FIG. 12 is a cross sectional front elevational view of the automobile vehicle occupant support assembly of FIG. 1; and

FIG. 13 is a series of exemplary cross sectional views taken through the automobile vehicle occupant support assembly of FIG. 1 showing different material additive layering options.

### DETAILED DESCRIPTION

The following description is merely exemplary in nature and is not intended to limit the present disclosure, application, or uses.

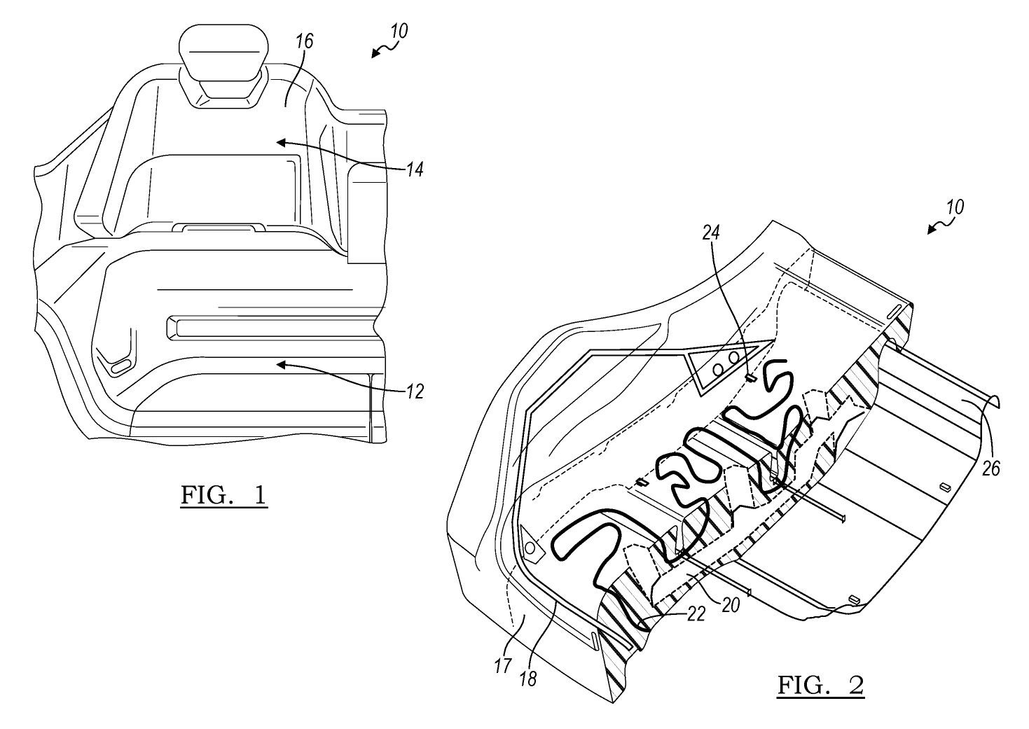

Referring to FIG. 1, an automobile vehicle occupant support assembly 10 according to principles of the present disclosure can define a vehicle seat member. The support assembly 10 includes a first portion 12 such as a seat back and a second portion 14 such as a head rest. Each of the first portion 12 and the second portion 14 are provided with a protective and abrasion resistant cover 16. A geometry of the support assembly 10 can vary from that shown within the scope of the present disclosure to accommodate multiple different geometries to suit different vehicle designs.

Referring to FIG. 2 and again to FIG. 1, the support assembly 10 includes a body 17 formed in an additive manufacturing process using one or more polymeric materials including but not limited to urethanes, made for example using isocyonates combined with polyols to create polyurethane. The material may be a thermoplastic polyurethane (TPU) or a thermoset polymer, and can vary in durometer, density, and compressibility over the cross section of the support assembly 10 as desired. Materials used in creation of the support assembly 10 are selected to minimize VOC emissions. The body 17 may be initially formed on a releasable substrate allowing the body 17 to be freely released and to include a geometry of the releasable substrate. The support assembly 10 may also be formed having one or more structural elements 18 embedded therein, which can be formed from the same polyurethane material as the body 17, or can be formed from one or more materials different from the material of the body 17, including but not limited to polyamides. According to several aspects, the at least one structural element 18 defines a stiffness greater than a stiffness of the body 17.

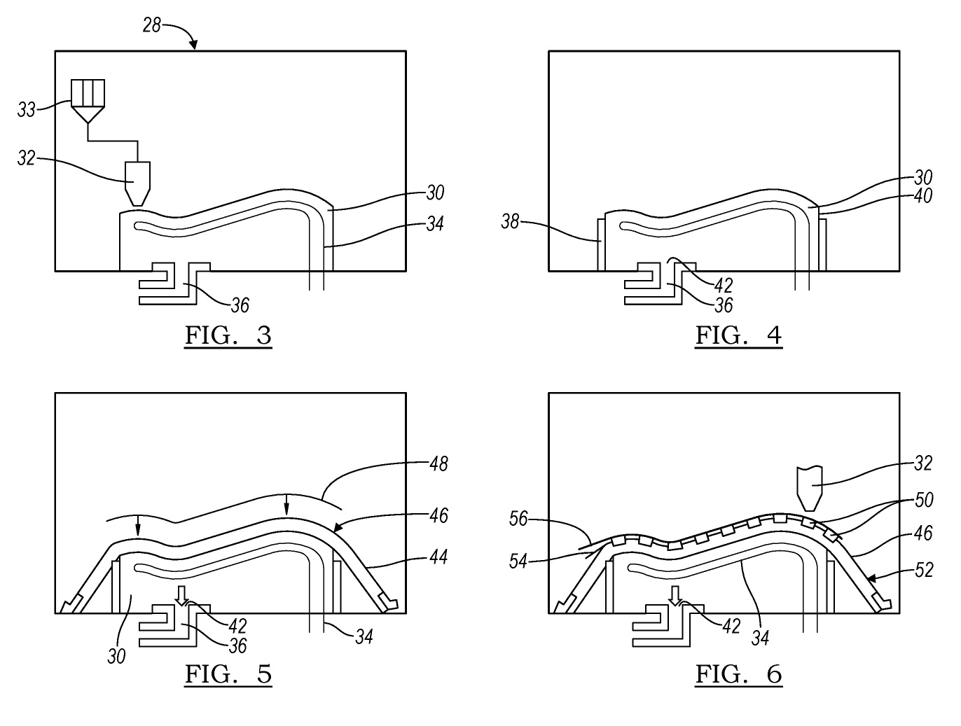

One or more cavities or passages 20 are formed within the body 17 acting for example to allow air flow for heating or cooling flow, and to locally reduce a weight of the support assembly 10 as desired. One or more wires 22 used for example as heating elements can be embedded in the support assembly 10 and routed as desired throughout the body 17 and connected externally to a power source of the vehicle. The support assembly 10 can further include one or more sensors 24, such as pressure or temperature sensors, used for example to identify occupant presence, localized temperature of the body 17 when the heating elements are energized, and the like. A substantially rigid suspension member 26, assisting for example as a reinforcement element, can be included with the support assembly 10. It is noted that each of the features discussed above with respect to the support assembly 10 are incorporated during an additive manufacturing process discussed below in greater detail in reference to FIGS. 3 through 10, used to create the support assembly 10, and therefore do not require subsequent installation or assembly to complete the support assembly 10.

Referring generally to FIGS. 3 through 10, the support assembly 10 is created using an additive manufacturing process as follows. With specific reference to FIG. 3, a sparse support structure 28 is initially created defining a mold 30 having a general shape desired for the support assembly 10 when completed. An outer surface of the mold 30 can define a releasable substrate. An additive manufacturing printing head 32 receives polymeric material for example in bead form from a source such as a multiple material storage hopper 33 and imparts or prints the polymeric material in multiple layers to create the support structure 28. The printing head 32 can be programmed to draw different materials from the multiple material storage hopper 33 for different passes or can apply different materials during each pass of the printing head 32. A heating element such as a plurality of resistance heating wires 34 can be embedded in the support structure 28 and connected to an external power source (not shown) to assist in maintaining a minimum or uniform temperature of the support structure 28 during subsequent operation of the printing head 32 used to create the support assembly 10. The support structure 28 is also connected to a vacuum source 36 which will be described in greater detail below.

Referring to FIG. 4 and again to FIG. 3, in a second step the support structure 28 is sealed using one or more side seal members 38 placed in direct sealing contact with a side wall 40 of the support structure 28 which act to prevent air flow into the sides of the support structure. A vacuum port 42 is added to the support structure 28 and placed in communication with the vacuum source 36.

Referring to FIG. 5, in a following or third step, a trim member 44 is placed in direct contact with a surface 46 of the support structure 28. A partial vacuum generated by the vacuum source 36 communicated via the vacuum port 42 draws the trim member 44 downward (as viewed in FIG. 5) onto the surface 46. A temporary mask 48 can be placed on the trim member 44 opposite to the surface 46. The temporary mask 48 has a shape substantially matching a shape or geometry of the surface 46. The temporary mask 48 is substantially resistant to air flow and therefore improves vacuum performance in initially retaining the trim member 44 in contact with the surface 46. Multiple holes, apertures, internal flow paths, and the like (not visible due to their small size) present in the support structure 28 assist vacuum communication between the vacuum source 36 and the surface 46 to draw the trim member 44 into physical contact with the surface 46 and through the trim member 44 to draw the mask 48 into contact with the trim member 44. A rigidity of the mask 48 maintains the desired shape of the trim member 44.

Referring to FIG. 6 and again to FIGS. 3 and 5, if present the temporary mask 48 is removed, the resistance heating wires 34 may be energized to achieve a desired temperature of the support structure 28 and the trim member 44, and the printing head 32 is operated to individually print one or more resilient polymeric material elements 50 onto a surface 52 of the trim member 44 in a non-planar orientation or pattern. The one or more resilient polymeric material elements 50 define a first of multiple layers of printed materials each made in successive passes of the printing head 32. One or more electrical circuits 54, 56 are placed on the surface 52 or embedded in the resilient polymeric material elements 50 during operation of the printing head 32. The electrical circuits 54, 56 can be subsequently used as heating elements, to energize or define one or more sensors, and the like.

According to several aspects, in lieu of individually placing pre-formed ones of the electrical circuits 54, 56, the electrical circuits 54, 56 can be themselves printed using the printing head 32 from a source of electrically conductive polymeric material supplied from the multiple material storage hopper 33. According to further aspects, in lieu of individually embedding pre-formed sensors, the printing head 32 can also be used to print sensors from a source of material suitable for sensors such as pressure sensors similar to strain gages, or from one or more materials suitable for creating temperature sensors.

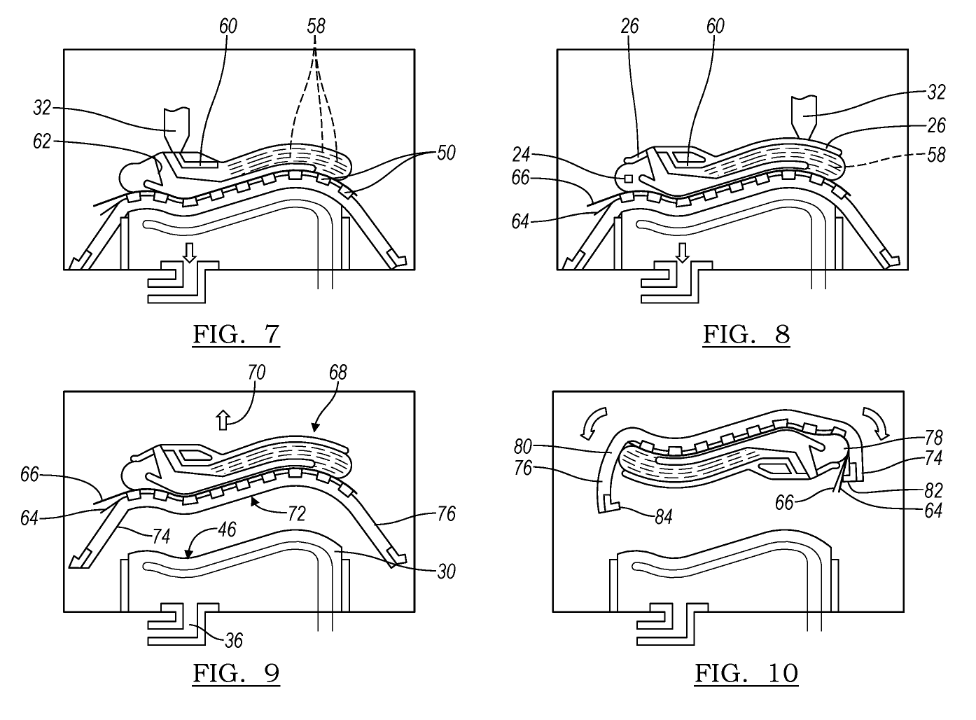

Referring to FIG. 7, additional resilient and rigid or hard polymeric material is added using the printing head 32 in a topologically optimized pattern to form additional support layers 58. As the support layers 58 are created, additional features such as one or more rigid support elements 60 are formed in the topologically optimized pattern, and material can be omitted at predefined locations during passage of the printing head 32 to create one or more open channels 62 in the topologically optimized pattern.

Referring to FIG. 8, following printing of the rigid support elements 60 and the open channels 62, the printing head 32 prints the suspension member 26. Leads 64, 66 extending from each of the electrical circuits 54, 56 are allowed to extend freely outward.

Referring to FIG. 9, following completion of all printing operations using the printing head 32, the vacuum of the vacuum source 36 is removed allowing a completed component 68 to be removed from contact with the surface 46 of the mold 30 in a direction 70. A face 72 of the completed component 68 substantially matches the geometry of the surface 46. Freely extending first and second arms 74, 76 of the trim member 44 which may or may not have printed material disposed thereon are also released.

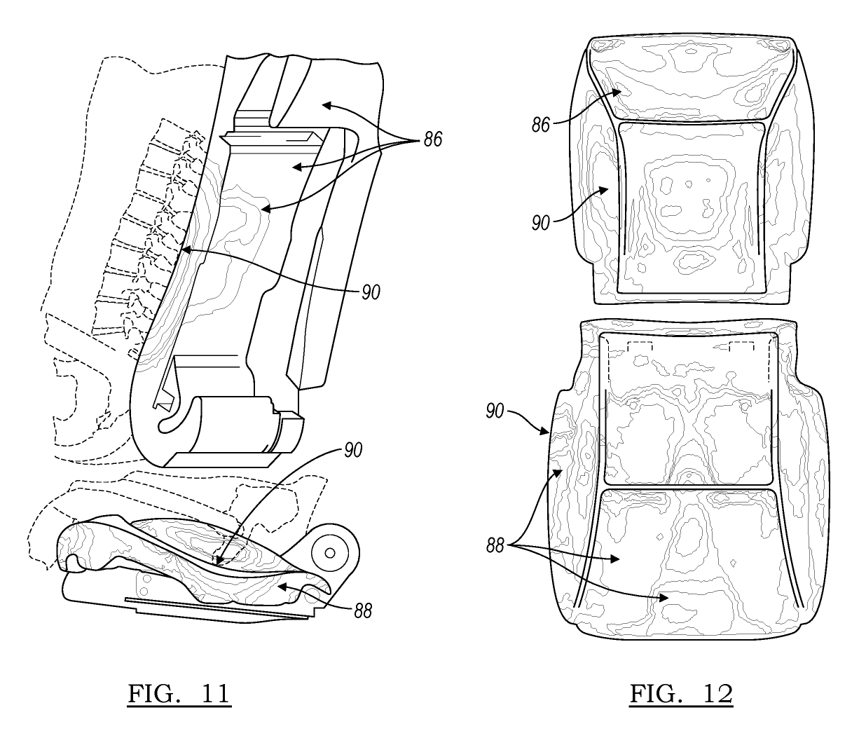

Referring to FIG. 10, in a final step the completed component 68 is shown after 180 degree axial rotation from the orientation shown in FIG. 9. The freely extending first and second arms 74, 76 are rotated as shown such that the first arm 74 is brought into contact with a first side 78 and the second arm 76 is brought into contact with a second side 80. Attachment devices 82, 84 may be provided at free ends of the first and second arms 74, 76 which can be subsequently connected to seat structure of the vehicle to complete installation of the completed component 68.

Referring to FIGS. 11 and 12 and again to FIG. 3, a support assembly 10 made using the additive manufacturing method of the present disclosure allows for insertion of different density material in different areas of the support assembly 10. For example, a low density material 86, 88 can be provided in areas such as in head rest, back rest, and tail-bone support areas. A high density material 90 can be provided where stiffness or additional occupant support is desired, such as at side wing areas and at buttock support areas where maximum occupant weight support is required. These different density materials can be selectively added in a single or in the same pass, at different printing head 32 positions, by selection of different printing materials from the multiple material storage hopper 33 during operation of the printing head 32.

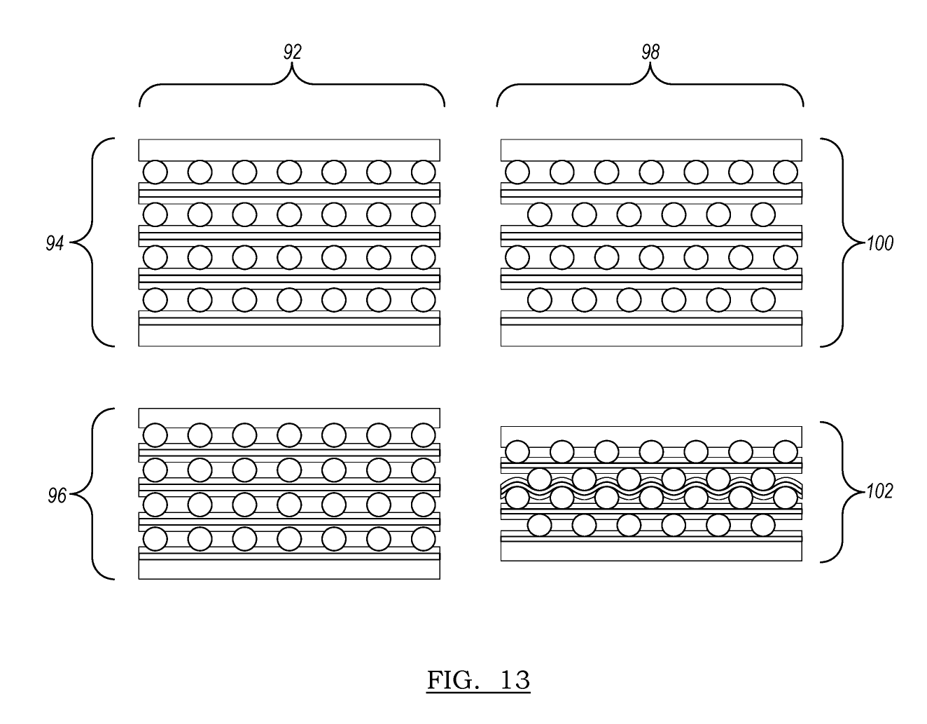

Referring to FIG. 13 and again to FIGS. 6 and 11 through 12, by selective positioning of the different density materials, different compressive strengths can be attained. For example, when individual layers of the resilient polymeric material elements 50 are oriented in a vertically aligned or stacked configuration 92, the difference under compressive loading between a substantially unloaded condition 94 and a loaded condition 96 indicates the vertically stacked configuration allows limited vertical compression of the layers of the resilient polymeric material elements 50.

In direct contrast, when individual layers of the resilient polymeric material elements 50 are oriented in a vertically staggered configuration 98, the difference under compressive loading between a substantially unloaded condition 100 and a loaded condition 102 indicates the vertically staggered configuration allows substantial vertical compression of the layers of the resilient polymeric material elements 50 in the loaded condition 102 compared to the loaded condition 96. The use of vertically stacked versus vertically staggered resilient polymeric material elements 50 in different layers of the support assembly 10 therefore can offer different compressive support in different areas. Such positioning of the resilient polymeric material elements 50 in vertically stacked versus vertically staggered configurations can be achieved by selective control of the printing head 32 deposition of material in each layer.

In addition to the vertically stacked configurations shown in FIG. 13, other geometric configurations such as pyramids, tetrahedrons, domes and the like can be used. This provides the option to have any style of lattice inside the system. The geometric configuration of the lattice can also be selected to change a stiffness of the system, as well as to provide the ability to change an energy rebound of the system. This provides for a system that is engineered not only to provide support, but also to provide different dynamic responses such as to reduce or eliminate vibrations and to reduce or eliminate high amplitude jounce impacts.

Although described herein for exemplary purposes as automobile vehicle seating and cushions, a support assembly 10 of the present disclosure is not limited to use in automobile vehicles. As further non-limiting examples, support assemblies 10 can also be used in marine craft, lawn and garden equipment, truck seats, bus seats, airplane seats, energy absorbing pads, racing cars and similar vehicles with custom built seats to keep a driver contained in for better control, military vehicles with custom designed energy absorbing support cushions, office furnishings, home furnishings, outdoor items including deck furniture, pillows, bedding components such as mattresses, stadium seating, auditorium and theater seating, school and church seating, and cushioning items a person can sit on or that needs to deflect or absorb energy.

A support assembly 10 made using the additive manufacturing method of the present disclosure offers several advantages. These include the substantial elimination of VOC emissions, improved recyclability, elimination of additional labor to add further features as the component design changes, open functional integration of features, the ability to change material stiffness in any desired area throughout the part, the capability to incorporate sharp corners as desired for aesthetics, the addition of voids where desired to reduce component weight or density or to provide ventilation ducting paths, the elimination of required assembly tools, and the capability to customize each component for individual users and between different models.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A support assembly, comprising:
a body including multiple layers of at least one polymeric material applied onto a releasable substrate;
a protective and abrasion resistant polymeric material cover applied at least partially over the body;
at least one polymeric material structural element positioned in the body;
at least one sensor positioned in the body; and
at least one passage formed within the body by selective omission of at least one of the multiple layers of the at least one polymeric material.

2. The support assembly of claim 1, wherein the body includes a trim member and wherein the at least one structural element is formed from a same material as the body and defines a stiffness greater than a stiffness of the body.

3. The support assembly of claim 1, wherein the body includes a trim member and wherein the at least one structural element is formed from a polymeric material different than the polymeric material of the body and defines a stiffness greater than a stiffness of the body.

4. The support assembly of claim 1, further including at least one wire embedded in the body.

5. The support assembly of claim 4, wherein the at least one wire defines an electrically conductive polymeric material.

6. The support assembly of claim 4, wherein the at least one wire defines a conductive metal embedded as a layer independent of the multiple layers of at least one polymeric material.

7. The support assembly of claim 1, wherein the at least one sensor defines a polymeric material embedded independent of the multiple layers of at least one polymeric material.

8. The support assembly of claim 1, wherein the body includes at least different durometers, different densities, and different compressibilities over a cross section of the support assembly.

9. The support assembly of claim 1, wherein the at least one polymeric material defines a urethane.

10. The support assembly of claim 9, wherein the at least one polymeric material defines a thermoplastic polyurethane (TPU) or a thermoset polymer.

11. A support assembly formed by an additive manufacturing process using a printing head, comprising:
a trim member;
a body having multiple layers of at least one polymeric material applied onto the trim member via the printing head, the multiple layers each having multiple resilient polymeric material elements;
a protective and abrasion resistant polymeric material cover applied over the body and the trim member using the printing head;
at least one structural element positioned in the body by operation of the printing head;
at least one sensor positioned in the body; and
at least one passage formed within the body by selective omission of the at least one polymeric material from the printing head as the printing head displaces during the additive manufacturing process.

12. The support assembly formed by an additive manufacturing process using a printing head of claim 11, wherein the at least one structural element defines a stiffness greater than a stiffness of the body.

13. The support assembly formed by an additive manufacturing process using a printing head of claim 12, wherein the at least one structural element is formed from a same material as the body, or is formed from a different polymeric material than the body.

14. The support assembly formed by an additive manufacturing process using a printing head of claim 11, further including at least one wire embedded in the body.

15. The support assembly formed by an additive manufacturing process using a printing head of claim 14, wherein the at least one wire defines an electrically conductive polymeric material applied via the printing head.

16. The support assembly formed by an additive manufacturing process using a printing head of claim 14, wherein the resilient polymeric material elements of the multiple layers of the resilient polymeric material elements are oriented in one of a vertically stacked configuration or a vertically staggered configuration.

17. The support assembly formed by an additive manufacturing process using a printing head of claim 11, wherein the at least one sensor defines a polymeric material applied using the printing head.

18. The support assembly formed by an additive manufacturing process using a printing head of claim 11, wherein:
the body varies in at least a durometer, a density, and a compressibility over a cross section of the support assembly; and.
the at least one polymeric material defines a urethane.

19. An automobile vehicle seat support assembly formed by an additive manufacturing process using a printing head, comprising:
a body having multiple layers of at least one polymeric material applied via the printing head, the multiple layers each having multiple resilient polymeric material elements;
a protective and abrasion resistant polymeric material cover applied over the body using the printing head;
at least one structural element positioned in the body by operation of the printing head, the at least one structural element having a stiffness greater than a stiffness of the body;
at least one wire embedded in the body, the at least one wire defining an electrically conductive polymeric material applied via the printing head;
at least one sensor positioned in the body formed of a polymeric material applied using the printing head; and
at least one passage formed within the body by selective omission of the at least one polymeric material from the printing head as the printing head displaces during the additive manufacturing process.

20. The automobile vehicle seat support assembly formed by an additive manufacturing process using a printing head of claim 19, wherein:
the individual layers of the resilient polymeric material elements are oriented in one of a vertically stacked configuration or a vertically staggered configuration; and
the individual layers of the resilient polymeric material elements are applied onto a trim member.
